(19) United States
(12) Patent Application Publication
(10) Pub. No.: US 2003/0120624 A1
(43) Pub. Date: Jun. 26, 2003

(54) System and method for efficiently installing and configuring device drivers in managed environments

(76) Inventors: Burton H. Poppenga, Eagle, ID (US); James S. Boyce, Meridian, ID (US); Jon Baker, Boise, ID (US)

Correspondence Address: HEWLETT-PACKARD COMPANY, Intellectual Property Administration, P.O. Box 272400, Fort Collins, CO, 80527-2400, US

(21) Appl. No.: 10/006,692

(22) Filed: Dec. 10, 2001

(51) Int. Cl. G06F 7/00

(52) U.S. Cl. 707/1

(57) ABSTRACT

A system for facilitating selection, installation, and configuration of device drivers in a managed environment. The system includes a first mechanism for automatically accessing information about a device for which a driver is to be installed on a computer connected thereto and providing a signal in response thereto. The information includes device type and operational capabilities. A second mechanism selects a driver for the device and installs and automatically configures the driver on the computer based on the signal. In a specific embodiment, the first mechanism includes a database that maintains the information, which is organized according to an asset identification number. The information includes first and second portions. The first portion of information is obtained and entered in the database upon installation of the device. The second portion of the information includes operating system and language information pertaining to the computer. The second mechanism includes a website portal accessible by via the computer for enabling downloading of the driver. The second portion of the information is obtained from headers that are automatically supplied to website portal user-interface software by a browser running on the computer and accessing the website portal. The user-interface software runs on the website portal and enables the user to enter the asset identification number into the website portal. The asset number enables the website portal to automatically select and/or build an appropriate driver package.

### BACKGROUND OF THE INVENTION

1. Field of Invention

This invention relates to managed devices and networks. Specifically, the present invention relates to systems and methods for efficiently identifying, installing, and configuring devices and associated drivers in managed environments.

2. Description of the Related Art

Managed environments are employed in various demanding applications including corporate and governmental printer and copier management applications. Such applications require efficient environments that facilitate hassle-free printing and copying.

A managed environment often includes a computer network running various software modules and user-interfaces to facilitate network device management. The computer networks often connect various computers, printers, copiers, and other network devices. The computers may directly connect to various peripheral devices, such as printers and copiers. A managing entity ensures efficient operation of the devices connected to the computers on the network. The managing entity may employ various software and hardware tools to create an efficient environment to facilitate device management.

Managed environments are often outsourced to outside managing entities. For example, large corporations, such as Ford Motor Company (Ford), may decide to delegate printer management tasks to an efficient outside specialist, such as Hewlett Packard Company (HP). A group such as the Digital Workplace Services (DWS) within HP may handle various printer management tasks, allowing the company (Ford) to focus on designing, manufacturing, and selling automobiles rather than managing printing environments. Printer management tasks may include physically installing printers on a network; ensuring that printers have sufficient paper, ink, and staples, and other consumables; ensuring effective printer operation by performing any necessary repairs; monitoring and accounting for costs of consumables used; and ensuring that appropriate printer drivers are installed and appropriately configured for all printer features and options.

Often not all of the networked computers are initially configured to print to all of the network printers. Consequently, users wishing to print to a certain printer must often install and configure appropriate printer drivers on their computers to enable printing to that specific printer.

Conventional managed environments require that individuals wishing to use a particular printer download and configure the appropriate printer driver from a website or other location. Unfortunately, conventional methods for selecting, installing and configuring printer drivers are often error-prone and undesirably inefficient and costly. For example, users must often scroll through lists of printer drivers to select the appropriate printer driver based on printer type. Users may inadvertently select the incorrect printer driver by selecting a driver for a different operating system, language, printer type, or selecting a driver that is not approved by the company's intellectual property department. After selecting the printer driver, the user must download and install the printer driver. After installing the printer driver, the driver must be configured to accommodate the features and options available to the printer, such as color printing, duplex printing, and so on. Furthermore, users must often know printer queue names, spoolers, or printer Internet Protocol (IP) addresses to appropriately configure the drivers. Individual users may lack sufficient knowledge to appropriately select, install, and configure the drivers. Consequently, users may waste significant time and effort attempting to install and configure printer drivers. Furthermore, if the drivers are not appropriately configured, various printer capabilities may go unused, resulting in additional inefficiencies and costs. These costs and inefficiencies are magnified in large enterprise applications involving thousands of printers.

To increase the efficiency of printer driver installation, various driver installation wizards may be employed. Unfortunately, these wizards require significant user input. Users may not know the answers to all of the questions asked by the wizard, such as whether the printer employs Postscript or Printer Control Language (PCL). The users must often research the answers or guess. Consequently, conventional driver installation wizards and methods remain undesirably tedious, costly, and prone to human error.

Hence, a need exists in the art for cost-effective system and method for efficiently and accurately selecting, installing, and configuring device drivers in a managed environment.

### SUMMARY OF THE INVENTION

The need in the art is addressed by the system for facilitating selection, installation, and configuration of device drivers of the present invention. In the illustrative embodiment, the inventive system is adapted for use in a managed environment. The system includes a first mechanism for automatically accessing information about a device for which a driver is to be installed on a computer and providing a signal in response thereto. The device is connected to the computer. The information may include device type and operational capabilities. A second mechanism selects a driver for the device and installs and automatically configures the driver on the computer based on the signal.

In a specific embodiment, the first mechanism includes a database that maintains the information organized according to an asset number or other identification number or name associated with the device. The information includes first and second portions. The first portion of information is obtained and entered in the database upon installation of the device. The second portion of the information includes operating system and language information pertaining to the computer.

The second mechanism includes a website portal accessible via the computer for enabling downloading of the driver. The second portion of the information is obtained from headers that are automatically supplied to website portal user-interface software by a browser running on the computer that is used to access the website portal. The user-interface software running on the website portal enables the user to enter the asset number or name into the website portal to enable the website portal to automatically select or build an appropriate driver package based on the asset number. The website portal includes database-searching software for enabling the user to search for the device or corresponding device asset number or name in the database based on capabilities of the device and/or proximity of the device to the computer.

The novel design of the present invention is facilitated by the second mechanism, which enables automatic driver selection, installation, and configuration based on previously stored information pertaining to devices installed in the managed environment. The present invention may employ pre-existing organized device information, which may not be known to individual customers, to automatically select, install, and configure drivers in a managed environment.

### BRIEF DESCRIPTION OF THE DRAWINGS

FIG. 1 is a block diagram of a system for facilitating device driver installation in a managed environment constructed in accordance with the teachings of the present invention.

FIG. 2 is a flow diagram of a method for preparing the system of FIG. 1 for device driver installations.

FIG. 3 is a flow diagram of a method adapted for use with the system of FIG. 1.

### DESCRIPTION OF THE INVENTION

While the present invention is described herein with reference to illustrative embodiments for particular applications, it should be understood that the invention is not limited thereto. Those having ordinary skill in the art and access to the teachings provided herein will recognize additional modifications, applications, and embodiments within the scope thereof and additional fields in which the present invention would be of significant utility.

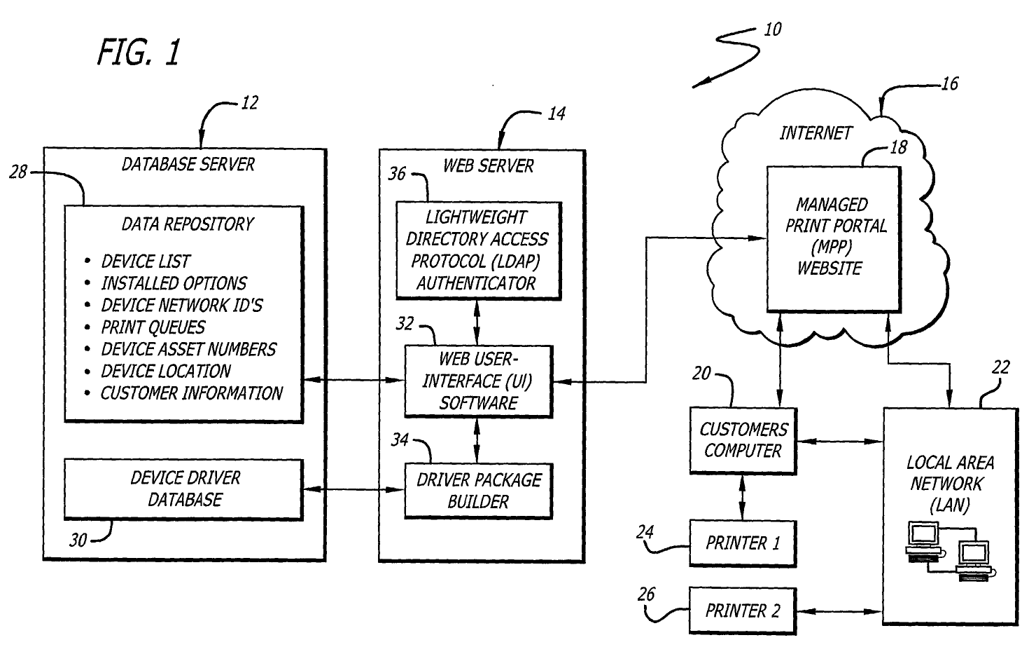

FIG. 1 is a block diagram of a system 10 of the present invention for facilitating device driver installation in a managed environment. For clarity, various well-known components, such as computer operating systems, browsers, power supplies, routers, hubs, and so on, have been omitted from FIG. 1. However, those skilled in the art with access to the present teachings will know which components to implement and how to implement them to meet the needs of a given application.

The system 10 includes a database server 12 in communication with a web server 14. The web server 14 is connected to the Internet 16 and hosts a managed print portal (MPP) website 18, which is accessible via the Internet 16. For illustrative purposes, a customer computer 20 and a Local Area Network (LAN) 22 are shown connected to the Internet 16 with access to the MPP website 18. The customer computer 20 communicates directly with a first printer 24. A second printer 26 is connected to the LAN 22 to which the customer computer 20 is connected. Those skilled in the art will appreciate that the LAN 22 may be replaced with another type of network, such as a Wide Area Network (WAN), without departing from the scope of the present invention.

The database server 12 includes a data repository 28 and a device driver database 30. The web server 14 runs a Lightweight Directory Access Protocol (LDAP) authenticator 36, web User-interface (UI) software 32 for hosting the MPP website 18 on the Internet 16, and a driver package builder 34. The LDAP authenticator 36 communicates with the web user-interface software 32, which communicates with the data repository 28 on the database server 12, and the driver package builder 34. Those skilled in the art will appreciate that the LDAP authenticator 36 may be replaced with another type of authenticator and/or directory access software, without departing from the scope of the present invention.

The web user-interface software 32 generates the MPP website 18. For illustrative purposes, the MPP website 18 is shown separate from the web server 14, however those skilled in the art will appreciate that the website 18 actually runs on the web server 14 via the web user-interface software 32. The web server 14 is connected to the Internet 16 and provides Internet access to the MPP website 18 thereby.

In operation, a managing entity controls installation and operation of various managed devices, such as the printers 24 and 26 associated with the network 22. The network 22, the printers 24 and 26, the customer computer 20, and the MPP website 18 are considered part of a managed environment. In the present specific embodiment, the managing entity owns and controls the database server 12, the web server 14 and associated website 18, and the various managed devices 24 and 26 of the network 22. The network 22 is owned by a customer of the managing entity, such as a corporation of government entity.

The customer contracts with the managing entity to provide a managed printing environment. The managing entity owns the printers 24 and 26 and is largely responsible for installing the printers 24 and 26, which are leased to the customer. The customer is often charged based on consumable consumption, the features of the printers employed, or via another leasing arrangement.

Upon installation of the printers 24 and 26 of the network 22, the managing entity assigns a unique asset number to each printer 24 and 26. Information about each printer is stored in the data repository 28 and is organized by asset number. The information stored for each asset number includes the printer type, installed options and capabilities, printer network identifications, printer queues, and so on. All information required for configuring a printer driver, other than perhaps the default language and operating system of the computers used to print to the printers, is stored in the data repository 28. Conventionally, information stored in a device data repository, such as the repository 28, is maintained, but is typically not used to facilitate automatic printer driver installation and configuration.

Upon initial installation of the printers 24 and 26 on the network 22, the various computers, such as the customer computer 20, that are connected to the network 22 are generally not pre-configured to print to all printers of the network. For example, the customer computer 20 may be initially configured to print to the first printer 24 but not configured to print to the second printer 26. Suppose that the customer associated with the customer computer 20 wishes to print to the second printer 26 to employ capabilities of the second printer 26 not available via the first printer 24. The customer must then obtain and install the appropriate driver on the customer computer 20 to enable printing to the second printer 26 via the customer computer 20. Conventionally, the customer associated with the customer computer 20 would follow a tedious process of manually searching for a driver on a website corresponding to the printer 26; downloading the driver; installing the driver; and configuring the driver. Conventional driver installation processes are typically undesirably error-prone and difficult for customers that lack detailed knowledge about the printer 26 and driver configuration and installation requirements.

The system 10 employs the information pre-stored in the data repository 28, which is collected during installation of the printers 24 and 26, to facilitate automatic printer driver installation for the customer computer 20. In the present specific embodiment, the customer first determines the asset number of the printer that they wish to print to. Suppose that the customer wishes to print to the second printer 26. The customer may physically walk to the second printer 26 and read the asset number of the printer from an asset label that is attached to the second printer 26. Alternatively, the customer may visit the MPP website 18 via the customer computer 20. The MPP website 18 employs the web user-interface software 32 running on the web server 14 to enable customer searches of the data repository 28.

Upon initially accessing the MPP website 18, the customer is asked to enter a username and password for authentication and identification purposes. The web server 14 employs the LDAP authenticator 36 to authenticate the user based on the user name and password. After entering a valid username and password, the web user-interface software 32 generates a customized web user-interface, which is displayed to the customer via the MPP website 18. The customized web user-interface provides printer search functionality and automatic driver installation and configuration capabilities.

If the customer does not observe the asset number of the second printer 26 by visual inspection, the customer may search the data repository 28 via the MPP website 18 for printers that are connected directly to the network 22 or that are connected to computers that are connected to the network 22. Different customers may have different privileges set, so that when a customer logs in to the MPP website 18, the resulting customized interface automatically accounts for these privileges. For example, a certain customer may not have privileges to print to a color printer. If the customer is not permitted to print to a color printer, then any search results for available printers matching predetermined search criteria, such as proximity and printer capabilities, will not include asset numbers of color printers.

The customer obtains the asset number of the desired printer 26 either by a search of the MPP website 18 or via visual inspection of an identification tag on the desired printer 26. The customer selects or enters the printer asset number into an appropriate field of the MPP website 18 to initiate automatic driver selection, downloading, installation, and configuring. The web user-interface software 32 employs the entered or selected asset number to access corresponding printer information in the data repository 28. The web user-interface software 32 then employs this information, along with any predetermined customer driver preferences, to select an appropriate initial basic driver. The web user-interface software 32 may employ the identity of the customer as determined via authentication, to ascertain which type of drivers are allowed and which are not allowed on the network 22. For example, some corporations prefer that PostScript drivers and not Printer Control Language (PCL) drivers be installed on the network.

The web user-interface 32 automatically determines a suitable driver for the customer computer 20 to enable printing to the desired printer 26. Furthermore, the web user-interface 32 determines the default language and operating system of the customer computer 20 via Hypertext Transport Protocol (HTTP) header information. This header information is automatically provided by the browser (not shown) running on the customer computer 20 and used to access the MPP website 18. The web user-interface 32 may provide a user confirmation screen to enable the user to confirm or change the operating system, the default language, or other predetermined editable configuration parameters.

The web user-interface 32 accesses driver information in the data repository 28 and forwards necessary driver configuration information in addition to the name of an automatically selected starting driver to the driver package builder 34. The driver package builder 34 retrieves the initially selected driver from the device driver database 30 and automatically generates an appropriate accompanying configuration file of files (such as .ini files), to accompany the driver installation. The automatically selected driver and accompanying configuration files are made available to the customer computer 20 via the MPP website 18 for automatic downloading, installation, and configuring.

When the appropriate driver for the desired printer 26 is downloaded and installed in the customer computer 20, the computer 20 can then print to the printer 26. If the customer computer 20 lacks the driver required to print to the first printer 24, the appropriate driver could be automatically downloaded, installed, and configured, using a similar procedure as used to install and configure the driver for the second printer 26. The customer only needs to observe or find the asset number of the printer 24, access the MPP website 18, and then enter the asset number in the appropriate field. Consequently, the system 10 avoids the otherwise tedious steps of manually locating, downloading, installing, and configuring an appropriate driver for a desired printer.

Those skilled in the art will appreciate that the number of mouse clicks or other user input to the MPP website 18 required to select, download, install, and configure an appropriate printer driver is minimized. In a preferred embodiment, only a single click or user input (the printer asset number) is required to trigger automatic driver downloading, installing, and configuring. Additional clicks or inputs, such as confirmation inputs, may be added to the process without departing from the scope of the present invention.

The functionality of the web user-interface software 32 described herein may be implemented by one skilled in the art with access to the present teachings via one or more well-known technologies, such as via JavaScript, Microsoft® Active Server Pages (ASP), Common Gateway Interfacing (CGI), Structured Query Language (SQL), and so on. Other modules, such as the driver build package 34, the device driver database 30, the data repository 28, and the LDAP authenticator 36, may be implemented via standard software packages, such as via Oracle and LDAP server software. The driver package builder 34 may be implemented by one skilled in the art, without undue experimentation, via a computer language such as C++.

Those skilled in the art will appreciate that the database server 12, the web 20 server 14, and the various modules therein may be implemented on one or more different computers without departing from the scope of the present invention. For example, the database server 12 and the web server 14 may be implemented on the same computer, while the LDAP authenticator 36 could be implemented on a separate computer. Furthermore, while the system 10 of FIG. 1 is discussed with respect to a managed printing environment, devices other than printers, such as copiers, may be managed via the system 10 of the present invention without departing from the scope thereof. In addition, the data maintained in the data repository 28 may be obtained via mechanisms other than manual entry upon installation of the printers 24 and 26. For example, the printers 24 and 26 in the managed environment could be equipped with special software that responds to an Applet that is running on the customer computer 20, which was downloaded from the MPP website 18. The Applet may request the information about one or more of the printers 25 and 26 from the special printer software running on the printers 24 and 26. The requested information from a desired printer may then be provided to the web user-interface software 32 to facilitate the building of a custom driver package for the desired printer. However, in the preferred embodiment, client-side code, such as Applets, Active X Controls, and so on are not installed in the customer environment by the present invention.

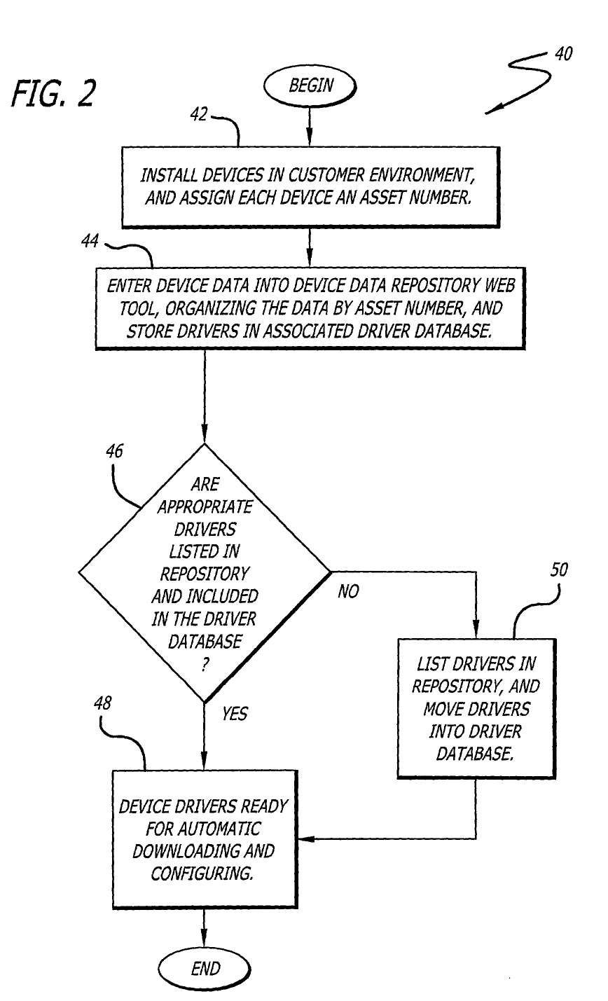

FIG. 2 is a flow diagram of a method 40 for preparing the system 10 of FIG. 1 for device driver installations. With reference to FIGS. 1 and 2, in an initial device-installation step 42, various managed devices, such as the printers 24 and 26 of FIG. 1 are physically installed in the managed environment associated with the network 22. Each device is assigned an asset number upon installation. The asset numbers are physically labeled on the installed devices. During device installation, data pertaining to each device, such as installed options, device network identifications, print queues, customer information, physical device location, network addresses, spoolers, and so on, is stored in the data repository database 28 in an information-collecting step 44.

Subsequently, in a driver-checking step 46, the device driver database 30 and repository 28 are scanned or otherwise analyzed to determine if all drivers corresponding to the installed devices are contained in the device driver database 30 and listed in the data repository 28. Those skilled in the art will appreciate that the data repository 28 and the device driver database 30 may be implemented via a single database without departing from the scope of the present invention.

If not all of the drivers for installed devices are included in the databases 28 and 30 as determined in a driver-checking step 46, then missing drivers are moved into the driver database 30. An appropriate device record is then entered into the data repository 28 in a driver-obtaining step 50. The missing drivers may be obtained from websites, such as via www.hp.com, or may be ordered directly from the device manufacturer. When the necessary drivers and driver configuration information is obtained and stored in the data repository 28 and the device driver database 30, then the system 10 is ready for facilitating automatic device driver downloading and configuring in the driver-downloading step 48. If the driver checking step 46 determines that all drivers and device configuration information are stored in the data repository 28 and the device driver database 30, then control is passed directly to the driver-downloading step 48.

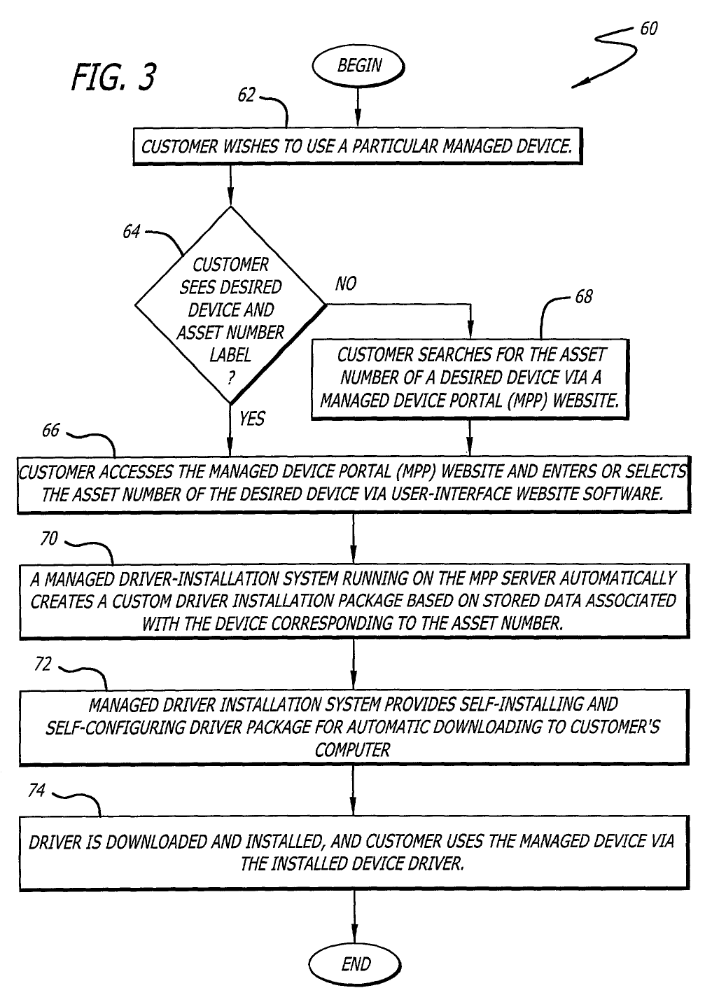

FIG. 3 is a flow diagram of a method 60 adapted for use with the system of FIG. 1. With reference to FIGS. 1 and 3, in an initial device-selection step 62, a customer decides to use a desired managed device, such as a printer (see 24 or 26 of FIG. 1), and wishes to download, install, and configure an appropriate device driver. If the customer sees the asset number of the desired printer, as determined in an asset-identification step 64, then control is passed to an asset-specification step 66. Otherwise, control is passed to an asset number-searching step 68.

In the asset number-searching step 68, the customer accesses the MPP website 18 of FIG. 1 and employs the search capabilities provided therein to search for the asset number of the desired device. For example, the customer may decide to search all printers located in the same building that the customer is located in. The MPP website 18 may then employs the web user-interface software 32 to search the data repository 28 for devices based on device proximity or general location, device capabilities, loading profile, and/or cost, and so on.

Customer information, such as customer location, is known for each customer and stored in a database, such as the data repository 28. Upon customer login to the website 18 and authentication via the LDAP authenticator 36, the customer's information in the data repository 28 is known and accessible by the web user-interface software 32. The web user-interface software 32 may use the location of the customer computer 20 and the location of available managed devices to perform proximity searches to provide the user with the device asset numbers of nearby devices. Upon obtaining the asset number of the managed device that the customer wishes to use (the desired device), control is passed to the asset-specification step 66.

In the asset-specification step 66, the customer accesses the MPP website 18 and enters the asset number of the desired device therein. Subsequently, in a driver building step 70, the web user-interface software 32 employs the asset number to access the device information stored in the data repository 28. The web user-interface software 32 employs the device information, the driver package builder 34, and language and operating system that were automatically obtained from the customer's browser to automatically select and customize an appropriate driver package to facilitate using the desired device.

In a subsequent driver-providing step 72, the customized driver package is automatically downloaded to the customer computer 20. The customized driver package may be implemented as a pre-zipped Extensible Markup Language (XML) file for automating the driver installation and configuration process for the customer. A client installer for processing the XML file is preinstalled on the customer computer 20. The customized driver package then automatically unpacks, installs, and configures itself to enable use of the desired device via the customer computer 20. After the driver packaged is downloaded and configured, the customer may then use the device via the installed device driver in a device-using step 74. The method 60 is then complete.

Thus, the present invention has been described herein with reference to a particular embodiment for a particular application. Those having ordinary skill in the art and access to the present teachings will recognize additional modifications, applications, and embodiments within the scope thereof.

It is therefore intended by the appended claims to cover any and all such applications, modifications and embodiments within the scope of the present invention.

What is claimed is:

1. A system for facilitating selection, installation, and configuration of drivers for devices connected to a network comprising:
first means for automatically accessing information about a device for which a driver is to be installed and providing a signal in response thereto, said device being in communication with a computer and
second means for selecting a driver for said device and installing and automatically configuring said driver on said computer based on said signal.

2. The system of claim 1 wherein said information includes device type and operational capabilities.

3. The system of claim 2 wherein said network is part of a managed environment and first means includes a database that maintains said information organized according to an asset number or other identification number or name associated with said device.

4. The system of claim 3 wherein said information includes first and second portions, said first portion obtained and entered in said database upon installation of said device.

5. The system of claim 4 wherein said second means includes a website portal accessible by via said computer for enabling downloading of said driver.

6. The system of claim 5 wherein said first means includes a user-interface running on said website portal for enabling said user to enter said asset number or name into said website portal to enable said website portal to automatically select or build an appropriate driver package based on said asset number.

7. The system of claim 6 wherein said website portal includes database software for enabling said user to search for said device or corresponding device asset number or name in said database based on capabilities of said device and/or proximity of said device to said computer.

8. The system of claim 7 wherein said second portion of said information includes operating system and language information pertaining to said computer based on headers automatically supplied by a browser running on said computer and accessing said website portal.

9. A system for facilitating automatic device driver selection, download, installation, and configuration for a selected device in a managed environment comprising:
first means for maintaining and organizing data and basic drivers for devices installed in said managed environment, said data sufficient to configure said basic drivers for each of said devices and
second means for automatically selecting, installing, and configuring an appropriate one of said basic drivers on a computer based on said selected device and via said data.

10. The system of claim 9 wherein said first means includes a database server running a data repository database and a device driver database.

11. The system of claim 10 wherein said second means includes a managed device portal website for enabling access to said system via said customer computer.

12. A method for facilitating device driver installation and configuration in a managed environment comprising the steps of:
assigning asset numbers to devices of said managed environment and organizing information needed to configure drivers for said devices by said asset numbers and providing organized information in response thereto;
determining one of said asset numbers corresponding to a device for which a driver is to be installed and configured on a computer in said managed environment;
entering said asset number into a managed device portal, said device portal having access to said organized information and running driver building software;
employing said driver building software to automatically construct a driver package via said asset number and said organized information; and
automatically installing and configuring a driver for said computer and via said driver package to enable use of said device by said computer.

13. A method for facilitating selection, installation, and configuration of drivers for devices connected to a network comprising the steps of:
automatically accessing information about a device for which a driver is to be installed, said device in communication with a computer, and said information including device type and operational capabilities and providing a signal in response thereto and
selecting a driver for said device and installing and automatically configuring said driver on said computer based on said signal.
